(19) United States
(12) Patent Application Publication
(10) Pub. No.: US 2019/0246652 A1
(43) Pub. Date: Aug. 15, 2019

(54) Pressure Packaged Dough Products and Systems

(71) Applicant: General Mills, Inc., Minneapolis, MN (US)

(72) Inventors: Kristi L. Bahe, Coon Rapids, MN (US); Steven J. Cox, Long Lake, MN (US)

(73) Assignee: General Mills, Inc., Minneapolis, MN (US)

(21) Appl. No.: 16/268,993

(22) Filed: Feb. 6, 2019

Related U.S. Application Data
(60) Provisional application No. 62/630,548, filed on Feb. 14, 2018.

(51) Int. Cl. A21D 10/02; B65D 81/20; A21D 2/18; A21D 6/00

(52) U.S. Cl. CPC A21D 10/025; B65D 81/2076; B65D 77/32; A21D 6/001; A21D 2/18

(57) ABSTRACT

A pressurized dough system includes a package defining an interior volume and a refrigerated developed dough product within the interior volume. The refrigerated developed dough product includes flour, water and pectin in an amount sufficient to substantially increase the internal pressure of the pressurized package as well as the bake specific volume of the dough.

### CROSS REFERENCE TO RELATED APPLICATIONS

This application claims the benefit of U.S. Provisional Application No. 62/630,548, filed on Feb. 14, 2018 titled “Pressure Packaged Sough Products and Systems”. The entire content of this application is incorporated herein by reference.

### TECHNICAL FIELD

The invention relates to pressurized refrigerated dough products containing pectin and pressurized systems containing the same. More specifically, the invention relates to refrigerated, developed dough products containing pectin.

### BACKGROUND

A refrigerated dough may be stored and sold in a pressurized helically wound cylindrical tube, or “can,” which allows for storage stability during refrigeration and ease-of-use by the consumer. Canned dough products have an internal pressure greater than the surrounding atmospheric pressure due to self-sealing properties of the canned dough system. After the dough is placed and sealed inside of the can, the dough releases carbon dioxide gas, expanding inside the can and eventually filling the entire interior volume of the can. This results in an effectively “self-sealed” pressurized can.

The internal pressure of the can must be carefully managed to prevent either under-pressurization or over-pressurization. One challenge in this regard is that relatively small changes to the dough ingredients or dough weight cause significant change in the resulting can pressure, which not only affects can performance but can also affect the baking attributes of the product.

### SUMMARY

Disclosed herein is a pressurized dough system including a pressurized package and a refrigerated, developed dough product containing water, flour and pectin. The pressurized package defines an interior volume. When the developed dough product is packaged within the pressurized package, the pressurized package has an interior pressure (PSI/g) that is at least 10% greater than the same product without pectin after 21 days of refrigerated storage. In one embodiment, the internal pressure of the package does not increase or decrease by more than 10% when stored under refrigerated conditions for 21 days.

Also disclosed herein is a method of preparing a packaged dough product. The method includes placing a developed dough product inside a pressurized package, sealing the pressurized package, allowing the developed dough product to expand inside an interior volume of the pressurized package to a raw specific volume from about 1.7 to about 1.8 cubic centimeters per gram (cm³/g) of the developed dough product, and storing the developed dough product in the pressurized package under refrigerated conditions for at least four weeks. After storage for at least four weeks under refrigerated conditions, the pressurized package has an interior pressure from about 0.02 to about 0.06 PSI/g.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a perspective view of an example pressurized package constructed in accordance with the present invention.

FIG. 2 is a flowchart depicting an exemplary method for preparing a packaged dough product in accordance with the present invention.

### DETAILED DESCRIPTION

Any specific numeral value listed herein includes a margin of error of +/−5%. Accordingly, a mass of 2.00 grams includes masses between 1.90 and 2.10 grams. The term “about” increases the margin of error to 10%. For numerical values expressed as percentages, the margin of error refers to the base numerical value. In other words, “about 20%” means 18-22% and not 10-30%.

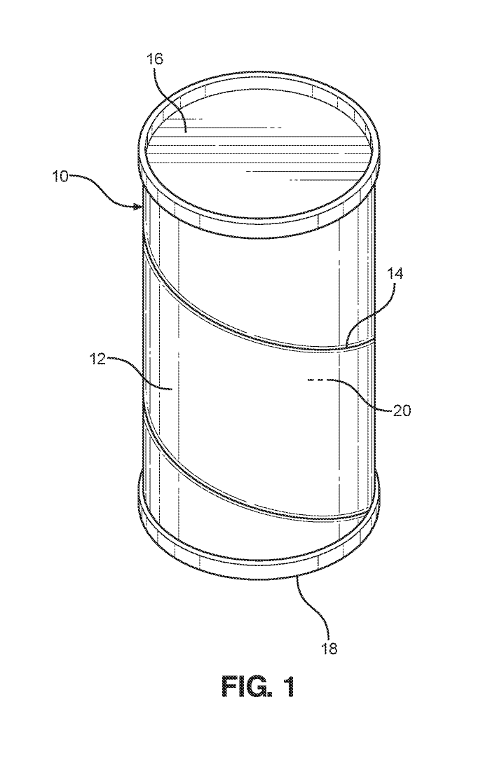

FIG. 1 is a perspective view of an example pressurized package 10 constructed in accordance with the present invention and defining an interior volume. In some embodiments, the package 10 is a substantially cylindrical can with a wound cardboard exterior 12. The wound cardboard exterior 12 can overlap at seams 14 and be sealed with a suitable adhesive. The package 10 can also have a first endcap 16 and a second endcap 18. The first endcap 16 and second endcap 18 can be substantially circular or any other suitable shape such that the package 10 is effectively sealed and no air is allowed to enter from the exterior atmosphere. In another embodiment, the first endcap 16 or second endcap 18 can be capable of venting so as to allow air or gas to escape from the interior of the package 10 to the exterior atmosphere. In yet another embodiment, the package 10 can be a self-sealing package. For example, as a refrigerated developed dough product 20 stored inside the package 10 develops and expands, the dough 20 releases carbon dioxide gas. The package 10 allows the gas to vent or be released to the exterior atmosphere and at the same time prevents air from entering the package 10 from the exterior atmosphere. Once the refrigerated dough product 20 has fully developed and expanded to the shape of the package 10, no empty space remains in the interior volume and the package 10 is “self-sealed.”

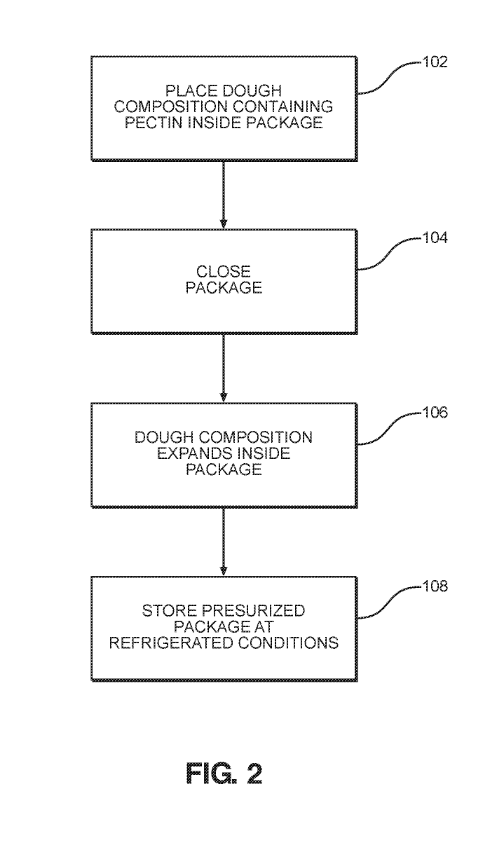

FIG. 2 is a flowchart depicting a method for preparing a packaged developed dough product in accordance with the present invention. In step 102, a dough (e.g., the dough product 20) is placed inside one open end of a cylindrical tube (e.g., the package 10). The dough contains pectin, the purpose of which will be detailed below.

In step 104, the open end is sealed, and the dough is enclosed inside the interior of the package. As discussed herein, the package can be sealed such that no gas can enter or exit the interior of the package. Alternatively, the sealed package can allow gas to exit the interior space. For example, the package can be vented such that gas can leave the interior space.

In step 106, the dough expands inside the interior of the package due to the formation of carbon dioxide as a result of a chemical reaction caused by the dough leavening system. In some embodiments, the dough composition expands to completely fill the interior of the package.

In step 108, the pressurized packaged developed dough is stored at refrigerated conditions, such as from about 35° F. to about 45° F. In some embodiments the pressurized package can be stored for a period of up to at least 28 days. In other embodiments, the package can be stored for a period of up to at least 75 days, up to at least 90 days or up to at least 120 days.

Controlling the internal pressure of canned dough products during refrigeration is critical to shelf stability as well as product performance during use. If the pressure is too low, the raw specific volume (RSV) of the dough and/or the baked specific volume (BSV) can be adversely affected. RSV is the volume of the dough after developing, but prior to baking, and is calculated by dividing the interior volume of the package by the initial weight of the dough inserted into the package. Higher internal pressure tends to be associated with higher RSV and BSV values, which are preferred as they indicate a larger, lighter, and less dense baked product, which can have a fluffier texture.

Internal package pressure can be affected by a variety of conditions, including package volume, the amount of dough placed in the package, the type and amount of leavener used and the flour:water ratio of the dough. There are a variety of circumstances where it can be beneficial to utilize a dough formulation that exhibits a relatively high pressure per gram of packaged dough so that less dough can be included relative to the package's volume. For instance, certain canned dough products include secondary packages placed inside the can that contain, for example, seasoning, icing or condiments. The secondary packages take up space inside of the can, thus requiring the dough to have a higher pressure per gram of dough. Additionally, it can be beneficial to utilize fewer can sizes with varying dough volumes.

Although a variety of factors contribute to the internal pressure of the package, it is difficult to increase the internal pressure of a package without adversely affecting the baking characteristics of the resulting dough. One known technique for increasing package pressure is to increase the amount of leavener used in the dough since the leavener is primarily responsible for generating the CO₂ that pressurizes the package. However, increasing the amount of leavening can reduce the BSV of the resulting dough.

The present invention utilizes pectin in the packaged dough formulation (e.g., the dough product 20) in amounts sufficient to increase the internal pressure/gram of dough by at least about 10%. In certain embodiments, the pectin comprises at least about 0.1 wt % of the dough, more particularly about 0.1 wt % to about 0.3 wt % of the dough and even more particularly from about 0.2 wt % to about 0.3 wt % dough or from 0.15 wt % to 0.25 wt % dough. In some embodiments, depending on the particular dough formulation, dough weight and package size, the package can have an internal pressure of about 0.02 PSI/g to about 0.06 PSI/g.

The dough composition generally also includes flour, water, fat, leavening agent and various flavorants, such as salt and sugar. The leavening agent can be a chemical leaving agent. The chemical leavening agent can include an acid and a base that can react to form carbon dioxide gas or any other such gas. This formation of gas causes the dough composition to develop and expand inside the interior volume of the package. Examples of such chemical leavening agents include sodium bicarbonate, potassium bicarbonate, monocalcium phosphate, sodium aluminum sulfate, and any other suitable leavening agent generally known to those skilled in the art. In other embodiments, the leavening agent is a natural leavening agent such as yeast, which converts fermentable sugars in the dough to carbon dioxide gas and ethanol, also allowing the dough to develop and expand.

### EXAMPLES

The present invention is described in the following examples. Since modifications and variations within the scope of the present invention will be apparent to those of ordinary skill in the art, the examples are intended as illustrations only. Unless otherwise noted, all parts, percentages, and ratios reported in the following examples are on a weight basis.

### Example 1

Example 1 investigated the effect of adding pectin on internal package pressure of a refrigerated dough. A control dough, labeled Control A in the Table 1 below and similar in composition to the Pillsbury Grands!™ refrigerated canned biscuit product, was prepared with a target weight of 59.25 grams, placed and sealed in a 2 14/16 inch by 5 9/16 inch spiral wound can and held at refrigeration temperature. Compositions 1-3 were produced in a similar manner as Control A except that pectin was added to each composition in concentrations of 0.1 wt %, 0.2 wt % and 0.3 wt %, respectively. A second control dough, labeled Control B in Table 2 below, was produced in a similar manner as Control A but with 10% less dough placed in the can. Compositions 4-6 were produced in a similar manner as Control B except that pectin was added to each composition in concentrations of 0.1 wt %, 0.2 wt % and 0.3 wt %, respectively.

After 21 days, the internal can pressure of Controls A and B and Compositions 1-6 were tested by can end deflection using a deflection gauge comprising a metal cylinder with a machined cup area that fits over the can end. Placement pins extend into the cup area and contact the can end. A digital depth indicator accurate to +/−0.0005 inches extends into the cup area and measures the vertical distance between the plane formed by the tops of the placement pins and the end of the can. The PSI of the can is measured according to the following equation:

PSI=((Deflection−0.007722)/0.00937)^{1.5}/g dough

The results are shown in Tables 1 and 2:

TABLE 1

| Composition | % Pectin | PSI (21 days) | % PSI change vs. control |
|---|---|---|---|
| Control A | 0 | 11.52 | 0 |
| 1 | 0.1 | 13.2 | 14.58 |
| 2 | 0.2 | 12.83 | 11.37 |
| 3 | 0.3 | 13.3 | 15.45 |

TABLE 2

| Composition | % Pectin | PSI (21 days) | % PSI change vs. control |
|---|---|---|---|
| Control B | 0 | 7.95 | 0 |
| 4 | 0.1 | 9.04 | 13.71 |
| 5 | 0.2 | 9.67 | 21.63 |
| 6 | 0.3 | 9.22 | 15.97 |

The results demonstrate that, even in concentrations as low as 0.1%, pectin was effective in increasing the internal pressure of the can by more than 10%.

### Example 2

Example 2 investigated the effect of adding pectin on internal package pressure of a refrigerated dough. A first control dough, labeled Control C in Table 3 below and similar in composition to the Pillsbury Grands!™ refrigerated canned cinnamon roll product, was prepared at a target weight of 35.4 grams, placed in a 2 4/16 inch by 7 4/16 inch spiral wound can along with a standard icing cup and held at refrigeration temperature. Compositions 7-9 were produced in a similar manner as Control C except that pectin was added to each composition in concentrations of 0.1 wt %, 0.2 wt % and 0.3 wt %, respectively. A second control dough, labeled Control D in Table 4 below, was produced in the same manner as Control C but with 10% less dough placed in the can. Compositions 10-12 were produced in a similar manner as Control D except that pectin was added to each composition in concentrations of 0.1 wt %, 0.2 wt % and 0.3 wt %, respectively.

After 21 days, the internal can pressure of Controls C and D and Compositions 7-12 were tested in the same manner as in Example 1. The results are shown in Tables 3 and 4:

TABLE 3

| Formula | % Pectin | PSI (21 days) | % PSI change vs. control |
|---|---|---|---|
| Control C | 0 | 15.04 | 0 |
| 7 | 0.1 | 15.17 | 0.87 |
| 8 | 0.2 | 17.24 | 14.63 |
| 9 | 0.25 | 16.59 | 10.31 |

TABLE 4

| Formula | % Pectin | PSI (21 days) | % PSI change vs. control |
|---|---|---|---|
| Control D | 0 | 10.46 | 0 |
| 10 | 0.1 | 11.17 | 6.79 |
| 11 | 0.2 | 12.15 | 16.16 |
| 12 | 0.25 | 12.63 | 20.75 |

The results demonstrate that, even in concentrations as low as 0.2%, pectin was effective in increasing the internal pressure of the can by more than 10%.

Based on the above, it should be readily apparent that the present invention provides a way to control the internal pressure of a packaged dough product during refrigeration to help achieve a desired shelf stability and bake performance. While certain preferred embodiments of the present invention have been set forth, it should be understood that various changes or modifications could be made without departing from the spirit of the present invention. In general, the invention is only intended to be limited by the scope of the following claims.

1. A pressurized dough system comprising:
a pressurized cylindrical tube defining an interior volume;
a developed dough contained in the interior volume of the tube, the dough including water, flour, leavener and a sufficient amount of pectin to increase the internal pressure of the tube by at least 10%, compared to the same dough without pectin, after storage under refrigerated conditions for 21 days.

2. The pressurized dough system of claim 1, wherein the dough includes at least about 0.1 wt % pectin.

3. The pressurized dough system of claim 2, wherein the dough includes from about 0.1 wt % to about 0.3 wt % pectin.

4. The pressurized dough system of claim 3, wherein the dough includes from about 0.2 wt % to about 0.3 wt % pectin.

5. The pressurized dough system of claim 3, wherein the dough includes from 0.15 wt % to 0.25 wt % pectin.

6. The pressurized dough system of claim 1, wherein the internal pressure of the tube does not increase or decrease by more than 10% when stored under refrigerated conditions for 21 days.

7. The pressurized dough system of claim 1, wherein the dough has a raw specific volume from about 1.7 to about 1.8 cubic centimeters per gram.

8. The pressurized dough system of claim 1, further comprising a secondary package contained in the interior volume of the tube.

9. The pressurized dough system of claim 8, further comprising a seasoning, icing or condiment in the secondary package.

10. A method of preparing a pressurized dough system, the method comprising:
placing a developed dough in an interior volume of a cylindrical tube, the dough including water, flour, leavener and a sufficient amount of pectin to increase the internal pressure of the tube by at least 10%, compared to the same dough without pectin, after storage under refrigerated conditions for 21 days; and
after placing the dough in the interior volume, allowing the tube to pressurize to create a pressurized tube.

11. The method of claim 10, further comprising, after placing the dough in the interior volume, sealing the tube.

12. The method of claim 11, wherein allowing the tube to pressurize includes allowing the dough to expand in the interior volume.

13. The method of claim 12, wherein allowing the tube to pressurize includes causing the dough to form carbon dioxide.

14. The method of claim 10, further comprising storing the pressurized tube under refrigerated conditions for at least 28 days.

15. The method of claim 10, wherein the dough includes at least about 0.1 wt % pectin.

16. The method of claim 15, wherein the dough includes from about 0.1 wt % to about 0.3 wt % pectin.

17. The method of claim 16, wherein the dough includes from about 0.2 wt % to about 0.3 wt % pectin.

18. The method of claim 16, wherein the dough includes from 0.15 wt % to 0.25 wt % pectin.

19. The method of claim 10, wherein the internal pressure of the tube does not increase or decrease by more than 10% when stored under refrigerated conditions for 21 days.

20. The method of claim 10, further comprising placing a secondary package in the interior volume of the tube.
